(19) United States
(12) Patent Application Publication
(10) Pub. No.: US 2013/0166245 A1
(43) Pub. Date: Jun. 27, 2013

(54) METHOD AND APPARATUS FOR REPORTING PATIENT RADIATION EXPOSURE

(71) Applicant: Sorna Corporation, Eagan, MN (US)

(72) Inventor: Cyrus Kurosh SAMARI, Burnsville, MN (US)

(73) Assignee: SORNA CORPORATION, Eagan, MN (US)

(21) Appl. No.: 13/691,820

(22) Filed: Dec. 2, 2012

Related U.S. Application Data
(60) Provisional application No. 61/566,597, filed on Dec. 2, 2011.

(51) Int. Cl. G01T 1/02

(52) U.S. Cl. CPC G01T 1/02; H04L 67/10
USPC 702/127; 709/217

(57) ABSTRACT

A method for generating radiation reports includes querying at least one source for a radiation exposure. The information for a patient is collected and a report is generated. Media having an instruction set for generating the reports can also include a viewer or viewing software for viewing the radiation report. An apparatus for generating the radiation reports can be a computer having modules comprised of hardware and software or both.

### RELATED APPLICATION

This application claims the benefit of U.S. Provisional Patent Application Ser. No. 61/566,597, filed on Dec. 2, 2011, which is incorporated by reference herein.

### TECHNICAL FIELD

Various embodiments described herein relate to a method and apparatus for reporting patient radiation exposure.

### BACKGROUND

For many years, it has been realized that people should limit their exposure to radiation from all sources. Concern over the biological effect of ionizing radiation began shortly after the discovery of X-rays in 1895. Over the years, numerous recommendations regarding exposure limits have been developed by the International Commission on Radiological Protection (ICRP) and other radiation protection groups. In general, the guidelines established for radiation exposure have had two principle objectives: 1) to prevent acute exposure; and 2) to limit chronic exposure to “acceptable” levels. Many occupations can potentially expose workers to various levels of radiation. Many times, workers wear radiation monitors.

One other common source of radiation is by way of the various tests and scans used in the medical and dental fields. Patients generally do not wear a radiation monitor during these tests and scans since exposure to radiation for tests is so infrequent. Many times, it is very difficult for physicians, dentists, health professionals, or medical facilities to determine how much radiation exposure a patient has received during previous scan(s). This is exacerbated by the fact that scans may be conducted by different facilities, by different health professionals, and by different technicians. Many times a patient goes to different places for treatment of various ailments. Hence, sometimes patients get exposed to dangerous levels of radiation during primary or secondary (sometimes re-scan) scans. However, patients and physicians treating these patients need to determine levels of radiation exposure to limit risks of other diseases for patients.

Current guidelines are based on the conservative assumption that there is no safe level of radiation exposure. In other words, even the smallest exposure has some probability of causing a stochastic effect, such as cancer. This assumption has led to the general philosophy of not only keeping exposures below recommended levels or regulation limits but also maintaining all exposure “as low as reasonable achievable” (ALARA). ALARA is a basic requirement of current radiation safety practices. It means that every reasonable effort must be made to keep the dose to patients, workers and the public as far below the required limits as possible.

### BRIEF DESCRIPTION OF THE DRAWINGS

FIG. 1 is a schematic view of a system that includes a plurality of networked devices as well as a device for data recording, according to an example embodiment.

FIG. 2 is a flow diagram for a method 200 of generating a report, according to an example embodiment.

FIG. 3 is a schematic view of a system that includes a plurality of networked devices as well as a device for data recording, according to an example embodiment.

FIG. 4 shows a schematic diagram of a computer system used in the system for driving business, according to an example embodiment.

FIG. 5 is a flow diagram associated with a computerized method, according to an example embodiment.

FIG. 6 is a flow diagram of a computerized method, according to an example embodiment.

FIG. 7 is a flow diagram of a computerized method, according to another example embodiment.

FIG. 8 is a flow diagram of a computerized method 600, according to still another example embodiment.

### DETAILED DESCRIPTION

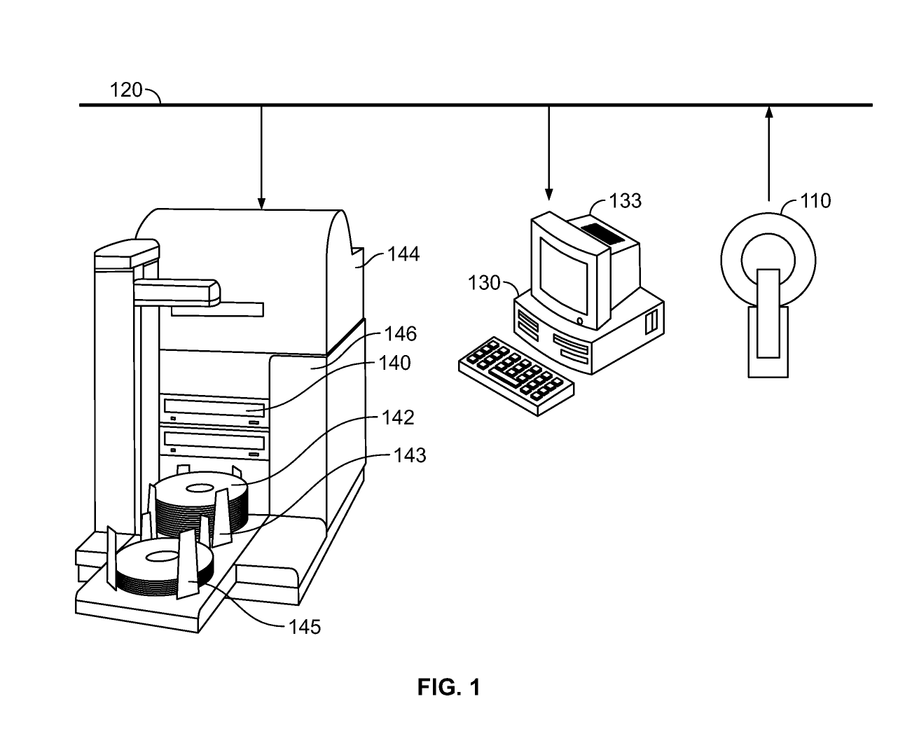

FIG. 1 shows a schematic view of one example of a system 100 that includes a plurality of networked devices 110 as well as a device for data recording 140, according to an example embodiment. A medical imaging device 110 such as an x-ray, cat scan, magnetic resonance imaging, sonogram or other device generates data indicative of an image or images of a patient. Although only one medical imaging device is shown, it should be understood that many medical imaging devices can be communicatively coupled to the communications network 120. The medical imaging device 110 also includes other data that may be added or associated with the patient image. The medical imaging device 110 either transmits the data indicative of the patient image, or stores the data for later transmittal through a communication network 120 such as the internet, a wide area network, or a local area network to a computer 130. In one example, the computer 130 can be used to select information to be stored by the compact disc writer 140 on compact discs, CDs, 142 and can select the information is to be printed by printer 144 on discs 142. Although CDs 142 are shown, any recording medium can be used for storage of information. The blank compact discs 142 are stacked in an input CD stack 143 waiting to be recorded. The CD autoloader 146 selects CDs 142 from the top of the input CD stack 143 to be recorded on and places the CDs 142 into the recorder 140. When the CD 142 has information stored on it, it is moved by the CD autoloader 146 to the printer 144 where selected information and logos or other graphics are printed on the CD 142 so that the users have a written record on the disc of the information stored thereon and logos identifying the producer of the disc or other information. The CDs 142 are then removed from the printer 144 by CD autoloader 146 and placed in the CD output tray 145. The CDs 142 can then be provided to patients, placed in patient files, or otherwise stored.

In another embodiment, the disc writer 140 is also a printer. For example the disc writer 140 can burn a disc with data and, while the disc remains in the same position, the printer can place a label or print a label on the outside surface of the disc. In other words, some disc writers 140 can also print to the disc without having to reposition the disc.

There are systems which automatically record or produce medical on various media, such as CDs, DVDs, and the like. These systems receive medical data in a format and automatically burn the data indicative of patient information to the media or store the data in a format associated with the media. The system is attached to a network of various devices from which it receives medical data. For example, information indicative of medical data can be received from medical archives, a modality, a server attached to a modality, a physician's station or the like. The devices attached to the network are not limited to those listed above. There is an infinite combination of various devices that can be attached to the network. The system can also receive information indicative of medical from devices on the network. The system, in some embodiments, can also retrieve information indicative of medical data from another network. The system can also query the network or more particularly the devices thereon and receive information indicative of medical information in response to the query. The system can also archive information to an medical archive location. In one embodiment, the data is placed on the communications network in a format set forth by a standard. One such standard is DICOM which sets forth a DICOM format. In the DICOM format, image data is associated with other data. The other data is carried in a set of headers which are determined by the DICOM format. Some of the other data can include data related to an amount of radiation received by a patient. For example, for a particular study there can be information about the parameters or settings used by a particular imaging device 110. From this data, an estimate of the amount of radiation received by a patient can be made. In another embodiment, the other data can be provided in other formats. For example, they can further be provided in an XML format. The other information in XML format could include the information about the parameters or settings used by a particular imaging device, patient identification information, study information and the like. The data related to one or more patients can be placed on such a system using a DICOM communication method, or by having the data in the standard format placed in another format in one or more “hot folders” associated with the media writer. A user of such an automated system can query a medical archive and request to receive one or more studies. Studies are specific images associated with a particular modality. The studies are very specific as to the type of view, the modality used, and further details related to the image associated with the study. The medical data is then usually processed and submitted to a hardware control software to record the medical data and print patient and study information on the media, such as a CD, DVD, and the like. It should be noted that the media writer 140 can also print to the media without repositioning the media from the position where it is burned. Also written or burned onto a media is a viewer of medical data. This allows a health care professional to place the media in any computing device and read the data on the media. U.S. Pat. Nos. 7,965,408; 8,045,214; and 8,059,304 issued to Soma Corporation set forth additional information related to such a system and are incorporated herein by reference.

The communications network 120 can be within a hospital or other medical facility, or even between medical facilities. The communications network 120 can even be a network of computers, such as the internet.

The DICOM format sets forth and defines many fields of information associated with a particular image generated by a medical imaging device. For a particular study, in one embodiment, a field is associated with the DICOM format that includes information regarding an amount of radiation exposure associated with the particular study. In another embodiment, an amount of radiation exposure associated with a particular study is stored elsewhere or otherwise associated with the study. The radiation information can be associated with a study and would not necessarily have to be placed in a particular format. Again, radiation information can be placed in another format and placed in a “hot folder”. In still other embodiments, an amount of radiation associated with a study is available from one or more websites that are accessible via the internet. For example, manufacturers, medical image providers, or another third party could make available radiation information for medical imaging devices. In one embodiment, the radiation exposure information could be as granular as to the particular study done on a particular imaging device. In another embodiment, the radiation exposure could be typical amounts for a type of machine identified. In still another embodiment, the radiation exposure information could include information for specific studies as well as general radiation exposure information for other studies. In this way, the radiation exposure information for the specific studies could be found and radiation information for studies not found could be estimated or use general amounts.

In one embodiment, the actual radiation exposure is not set forth in the header information. Other values related to the modality, position, exposure time, scan dark, radiation setting, radiation mode, average pulsed width, filter type, generator power, collimator type, body part thickness, date of last calibration, and the like are also set forth in the header of a DICOM format file. It should be noted that these are just a few of the values set forth in the header of a DICOM format file, and that there are many others that are related to an amount of radiation that may have been received. From such header information, and amount of radiation received for a particular study can be estimated. The estimates can be quite granular. For example the estimates may be down to a particular study in a particular position. In addition, the estimates can estimate the amount of radiation received by a particular body part, such as the head, hip, chest, abdomen and the like. The information can be taken from the header information and an estimate can be calculated. The estimate can be calculated on a local machine, a remote machine, or in the cloud. The estimates can be stored or placed in the database for a particular study or set of studies. The estimates can be made and then collected to determine amount of radiation received by a patient, or an amount of radiation received by a particular body part of a patient. This can be then sent to a physician or provided on a media as a report for another health care professional.

It should be noted that the report can also be generated on the local computer, or at a remote computer such as a server committed to fully coupled to the cloud. In addition, a report may be generated from XML data. The XML data could be data similar to that found in the DICOM header information. The XML data could include information from which an amount of radiation could be estimated. The report could be generated from XML data. This report could then be converted to a DICOM report. Of course, in another embodiment, the data needed to estimate the amount of radiation received could be extracted or parsed from the DICOM header, and a report could be generated in DICOM format. In short, a report can be generated from the DICOM header information or from other information that is related to an estimate of an amount of radiation. The report can be in non- DICOM format or and DICOM format. For example, the report can be in any type of format that can be read by a healthcare professional.

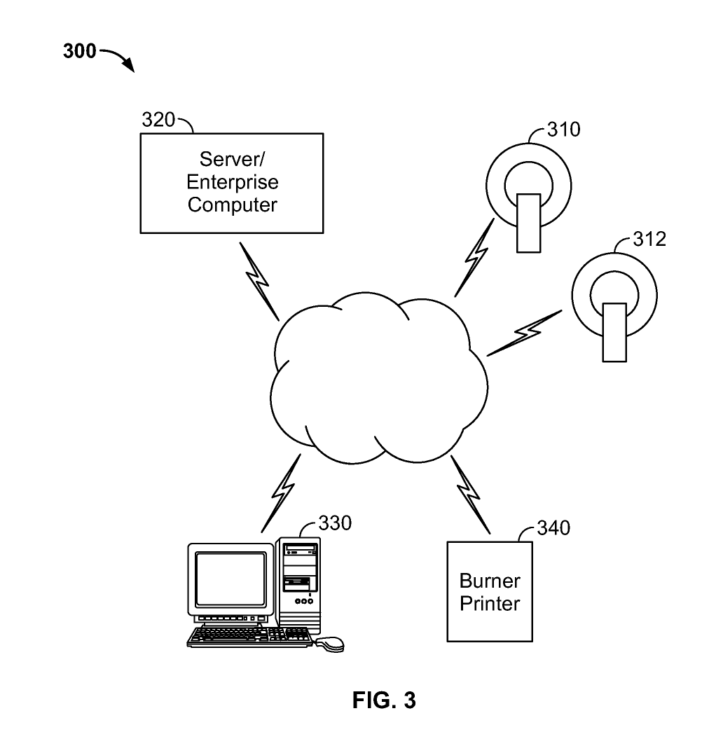

FIG. 3 is a schematic view of a system 300 that includes a plurality of networked devices as well as a device for data recording 340, according to an example embodiment. The system or network 300 includes a first imaging device 310 and the second imaging device 312 which are attached to the network. The network connection is depicted by the cloud shown in FIG. 3. Also connected to the network 300 is an enterprise computer or server computer 320. The network also includes a printer burner 340. This printer and burner 340 can be separate machines, or a combination machine that does both burning (recording) and printing. The recording and printing can be done while maintaining the media in a fixed position or relatively fixed position. In another embodiment the media may be placed in a first position to record or burn data to a media, and is placed in a second position to print or otherwise affix a label to a fixed media. Also attached to the network 300 is a computer 330. The computer 330 can be an interface to the network to receive or direct information flow and computations the various components 310, 312, 320, 330, 340 attached to the network 300. Should be noted that computations can be done in any of the components. In addition, a report can be stored in any of the components, such as in a memory associated with one of the components. A radiation report can also be placed on a media that is output from a printer burner 340. In one embodiment a viewer for the radiation report is also recorded or burned to the media associated with the printer burner 340. A viewer can also be placed on any of the components attached to the network 300.

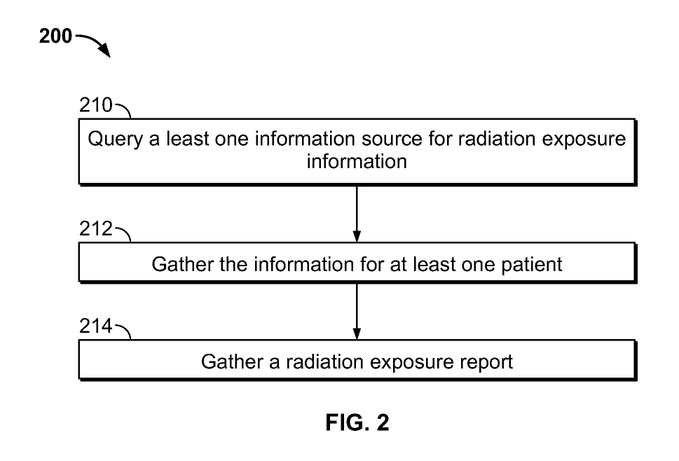

FIG. 2 is a flow diagram for a method 200 of generating a report, according to an example embodiment. The method 200 includes querying at least one information source for radiation exposure information, 210. The information is gathered for at least one patient 212, and a radiation exposure report is generated 214. In some instances the only information source queried 210 might be a particular imaging device 110. In another instance, all the imaging devices associated with one institution may be queried for radiation exposure levels associated with various studies. The query is not limited to a particular institution. A plurality or multiplicity of institutions could be queried. In still another embodiment, radiation information could be gathered from one or more websites that include the specific radiation exposure for specific studies or even general levels of radiation associated with a type of study. The information is gathered for one patient 212. Of course, the information can be gathered for more than one patient. From the information gathered a report is generated 214. The report can be in any form. The report can be any type of presentation that shows radiation exposure. For example, the report may be in the form of a bar graph or another graph that depicts radiation exposure. The graph could also be a warning signal showing exposure in a warning zone or in a red zone so that a medical professional could quickly assess the risk of exposing the patient to more radiation against the risk of not using the diagnostic tool (imaging apparatus). The report could merely be a set of numbers. The report could be in any format as well. The report could be a PDF file, an EXCEL spreadsheet, a WORD document, or the like. In one embodiment, the report could be for all the studies that could be located for a particular patient, even though the medical professional may be interested and have received information on a subset of the total number. In another embodiment, the report could be limited to the radiation exposure for a subset of studies sought. The report could be generated and sent to an attending physician via E-mail or text message and would not have to be placed on removable or other media.

It should be noted that the above method can be computerized. If the method 200 is computerized, it can be programmed into a memory of a general purpose computer. The computer and instructions form a special purpose machine. The instructions, when programmed into a memory of a general purpose computer or even the microprocessor of a specialized machine, are in the form of a non transitory set of instructions. The method can be carried out as modules for doing the specific steps of the method. The modules can be software, hardware, or a combination of software and hardware. It should also be noted that a computerized method 200 can be implemented in any machine attached to a network. For example, the method 200 could be an instruction set run on a large server attached to the cloud, or could be on a small computer also attached to a network. In fact a portion of the estimate could be determined at one computer and another portion of the estimate could be determined at another computer. Thus the computation could be determined by two computers on a network. In addition, the computation of the estimate could even be made by a microprocessor in a printer and recorder device. In other words the microprocessor in some imaging devices or even in printer devices could be used to make estimates on the fly to place in or otherwise associate with a particular image for a particular study.

In many instances, medical data is placed on media. Automated systems can automatically produce medical images on CDs, DVDs, or other media. These systems receive medical data (for example in DICOM format) using a DICOM communication method, or by having the data placed in one or more “hot folders” in the system. A computer can be one such automated system. A printer having a microprocessor and memory can be another automated system. A user of such an automated system can query a medical archive and request to receive one or more studies. The medical data is then usually processed and submitted to a hardware control software to record the medical data and to record information related to the medical data. Many times a viewer of medical data is also recorded to the media (CDs, DVDs or the like). The information can also be parsed or extracted for printing information related to the patient and study information onto the CD, DVD, or other media.

The automated system is attached to a network of various devices from which it receives medical data. For example, information indicative of medical data can be received from medical archives, a modality, a server attached to a modality, or the like. There are many varied medical information systems associated with hospitals, clinics, health care systems and the like. The automated system can also receive information indicative of medical from devices on the network. The automated system, in some embodiments, can also retrieve information indicative of medical data from another network. The automated system can also query the network, or more particularly the devices thereon, and receive information indicative of medical information in response to the query. The automated system can also archive information to a medical archive location. The medical archive can be a server dedicated to storing such data or can be a cloud-based storage solution that is geared toward general storage or medical data information storage.

A set of software instructions is also recorded to the media that includes obtaining radiation exposures for various studies, and producing a radiation exposure report. In essence, the software instructions carry out the method of FIG. 2 and described above. In addition to burning or recording patient study information on one or more CDs, DVDs. or the like, radiation information is also recorded to the media. Gathered radiation information may be recorded onto the CD or other media, or gathered information collected and formed as a report may be recorded onto the CD, DVD, or other media. In still another embodiment, a radiation exposure report, for each study that has one, is recorded. It is important to note that a viewer for the radiation exposure report is also recorded to the media. Adding the viewer is necessary to ensure a proper relay of the information to the physician or institution that receives the CD, DVD, or other media. In other words, when the CD, DVD, or other media is read, the report might be the first item displayed so a healthcare professional will see it. Depending on the format of the report, this viewer can be part of the patient medical viewer, or be activated by a “button” on the medical viewer or simply be executable or accessible on the CD, DVD, or the like.

It is also possible that there is no physical report on the disc (CD, DVD, or the like). A radiation exposure report is then simply generated “on the fly” by utilizing the medical viewer or some other code executed by the medical viewer or standalone code on the disc.

It should also be noted that the report may not be related to a particular patient. Furthermore should also be noted that a report can be formed from data sent to a particular component, such as those shown in FIGS. 1 and 3. Other types of reports are possible, including a report related to an operator operates a particular imaging device, or when a particular imaging device produces a type of study. Again the reports may be stored on a physical media, such as that the burner printer 340, or can be stored on a component attached to a network such as network 100 or network 300.

When the report is related to only the studies recorded on a particular disc, the report can be generated as follows. Once the study(ies) have been received, and it is determined which one(s), any or all (usually determined by a configuration file where proper modality(ies) are selected) need to have a report generated for, the system/software, depending on the implementation, will execute a software module and pass to it the necessary information of the study(ies) for which a report is being generated. The report generation module in turn returns one or more reports for each study passed to it. The resulting report(s) are then matched to the original study(ies) and burned or recorded along with the one or more studies on the DISC(s) Once the study(ies) have been received, and it is determined which one(s), any or all (usually determined by a configuration file where proper modality(ies) are selected) need to have a report generated for, the system/software, depending on the implementation, will execute a software module and pass to it the necessary information of the study(ies) for which a report is being generated. The report generation module in turn returns one or more reports for each study passed to it. The resulting report(s) are then matched to the original study(ies) and burnt along with it (them) on the DISC(s) .

The radiation exposure report generation software may reside on the same system, or it could be accessible via the network (local or on the internet). In case there is no report stored on the DISC (only report generation software), that software is burnt on the DISC along with medical data to generate the reports on-the-fly.

The radiation exposure report generation software may reside on the same system, or it could be accessible via the network (local or on the internet). In case there is no report stored on the disc (only report generation software), software is recorded to the disc along with medical data to generate the reports on-the-fly.

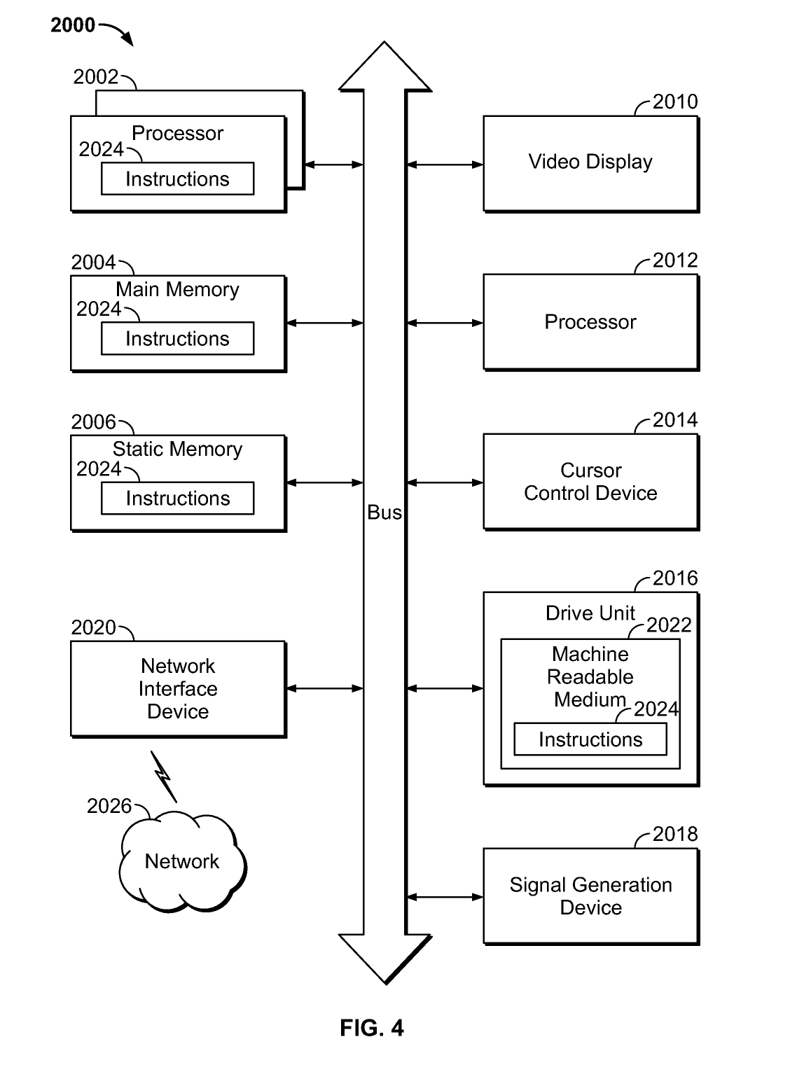

FIG. 4 shows a diagrammatic representation of a computing device for a machine in the example electronic form of a computer system 2000, within which a set of instructions for causing the machine to perform any one or more of the methodologies discussed herein can be executed or is adapted to include the apparatus for generating radiation reports as described herein. In various example embodiments, the machine operates as a standalone device or can be connected (e.g., networked) to other machines. In a networked deployment, the machine can operate in the capacity of a server or a client machine in a server-client network environment, or as a peer machine in a peer-to-peer (or distributed) network environment. The machine can be a personal computer (PC), a tablet PC, a set-top box (STB), a Personal Digital Assistant (PDA), a cellular telephone, a portable music player (e.g., a portable hard drive audio device such as a Moving Picture Experts Group Audio Layer 3 (MP3) player, a web appliance, a network router, a switch, a bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 2000 includes a processor or multiple processors 2002 (e.g., a central processing unit (CPU), a graphics processing unit (GPU), arithmetic logic unit or all), and a main memory 2004 and a static memory 2006, which communicate with each other via a bus 2008. The computer system 2000 can further include a video display unit 2010 (e.g., a liquid crystal display (LCD) or a cathode ray tube (CRT)). The computer system 2000 also includes an alphanumeric input device 2012 (e.g., a keyboard), a cursor control device 2014 (e.g., a mouse), a disk drive unit 2016, a signal generation device 2018 (e.g., a speaker) and a network interface device 2020.

The disk drive unit 2016 includes a computer-readable medium 2022 on which is stored one or more sets of instructions and data structures (e.g., instructions 2024) embodying or utilized by any one or more of the methodologies or functions described herein. The instructions 2024 can also reside, completely or at least partially, within the main memory 2004 and/or within the processors 2002 during execution thereof by the computer system 2000. The main memory 2004 and the processors 2002 also constitute machine-readable media.

The instructions 2024 can further be transmitted or received over a network 2026 via the network interface device 2020 utilizing any one of a number of well-known transfer protocols (e.g., Hyper Text Transfer Protocol (HTTP), CAN, Serial, or Modbus).

While the computer-readable medium 2022 is shown in an example embodiment to be a single medium, the term “computer-readable medium” should be taken to include a single medium or multiple media (e.g., a centralized or distributed database, and/or associated caches and servers) that store the one or more sets of instructions and provide the instructions in a computer readable form. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, tangible forms and signals that can be read or sensed by a computer. Such media can also include, without limitation, hard disks, floppy disks, flash memory cards, digital video disks, random access memory (RAMs), read only memory (ROMs), and the like.

The example embodiments described herein can be implemented in an operating environment comprising computer-executable instructions (e.g., software) installed on a computer, in hardware, or in a combination of software and hardware. Modules as used herein can be hardware or hardware including circuitry to execute instructions. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software programs for implementing the present method(s) can be written in any number of suitable programming languages such as, for example, Hyper text Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Perl, UNIX Shell, Visual Basic or Visual Basic Script, Virtual Reality Markup Language (VRML), ColdFusion™ or other compilers, assemblers, interpreters or other computer languages or platforms.

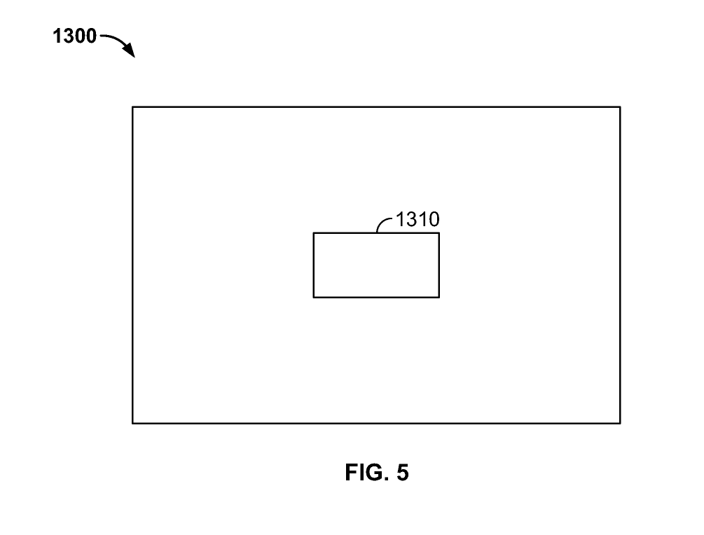

FIG. 5 is a schematic drawing of a machine readable medium 1300 that includes an instruction set 1310, according to an example embodiment. The machine-readable medium 1300 that provides instructions 1310 that, when executed by a machine, cause the machine to perform operations including eliciting and receiving an input to identify a selected investment, and eliciting and receiving an initial offering price for the investment. The machine readable medium 1300 also includes instructions that, when executed by a machine, cause the machine to perform operations that include receiving an input related to prompt displayed on a recycling container, identifying a marketing opportunity associated with the prompt, identifying the source of the received input, and sending the marketing opportunity to the source.

The present disclosure refers to instructions that are received at a memory system. Instructions can include an operational command, e.g., read, write, erase, refresh, etc.; an address at which an operational command should be performed; and the data, if any, associated with a command. The instructions can also include error correction data.

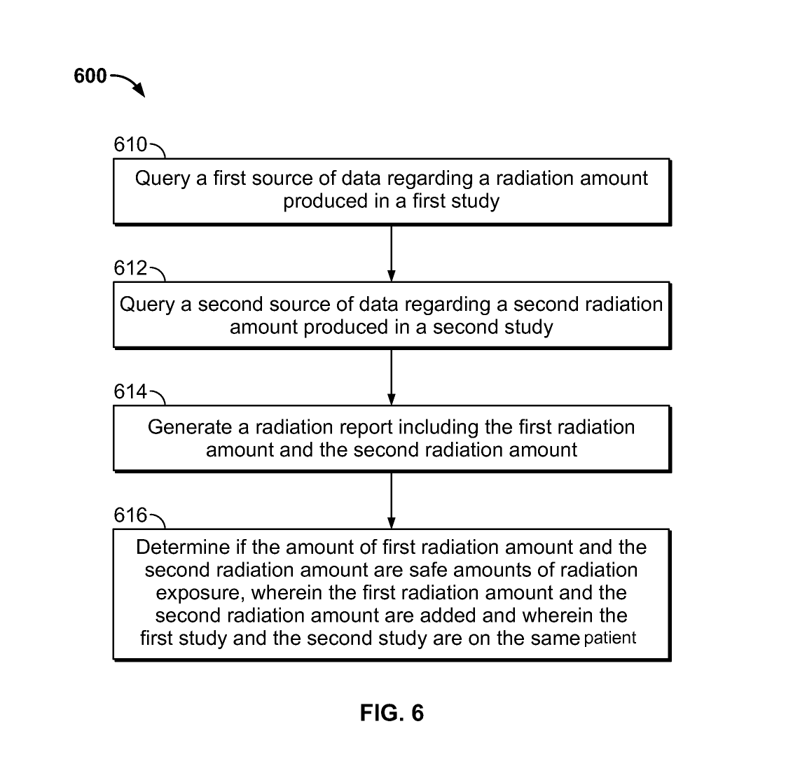

FIG. 6 is a flow diagram of a computerized method 600, according to an example embodiment. The computerized method 600 includes querying a first source of data regarding a radiation amount produced in a first study 610, and querying a second source of data regarding a second radiation amount produced for a second study 612. The computerized method 600 also includes generating a radiation report including the first radiation amount and the second radiation amount 614 and determining if the amount of first radiation amount and the second radiation amount are safe amounts of radiation exposure when the first radiation amount and the second radiation amount are added 616. Of course, the first study and the second study are on the same patient. The first study and the second stud, in one embodiment, can expose an organ of a patient to the first radiation amount and the second radiation amount. The radiation report can be specific to an organ or can be specified in other ways. One radiation report can be generated for an amount of general radiation exposure of the body of the patient. In one embodiment, the first study, the second study, and the radiation report are recorded onto a portable media. At least one of the first source of data regarding a radiation amount produced in a first study and the second source of data regarding a radiation amount produced in a second study is a modality. In another embodiment, at least one of the first source of data regarding a radiation amount produced in a first study and the second source of data regarding a radiation amount produced in a second study is a device that produces radiation. In still another embodiment, at least one of the first source of data regarding a radiation amount produced in a first study and the second source of data regarding a radiation amount produced in a second study is a medical data archive. The radiation information regarding studies can be stored in the header of a DICOM file, at a storage location on any device or a stand alone computer or server. In yet another embodiment, at least one of the first source of data regarding a radiation amount produced in a first study and the second source of data regarding a radiation amount produced in a second study is at a cloud storage location.

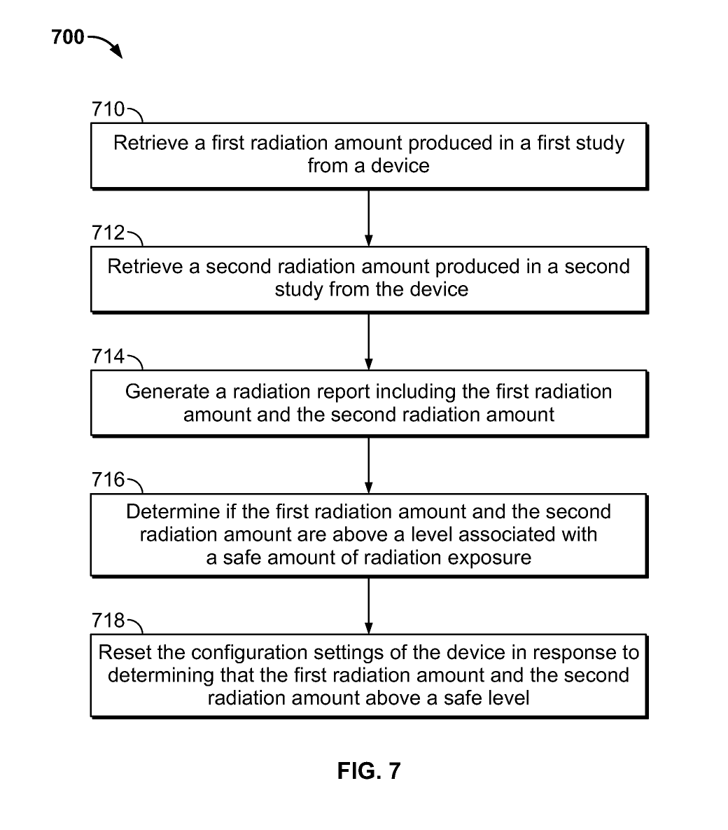

FIG. 7 is a flow diagram of a computerized method 700, according to another example embodiment. The computerized method 700 includes retrieving a first radiation amount produced in a first study from a device 710, retrieving a second radiation amount produced in a second study from the device 712, and generating a radiation report including the first radiation amount and the second radiation amount 714. The method 700 also includes determining if the first radiation amount and the second radiation amount are above a level associated with a safe amount of radiation exposure 716. If one or both of the radiation amounts are over a safe amount of radiation exposure, the method includes resetting the configuration settings of the device to bring the radiation levels to a safe level or a level below the safe level 718. In some embodiments, the determination that the first radiation amount and the second radiation amount are above a safe level triggers a notification of the condition. Technicians, administrators, regulators or the like can be notified of the radiation amound above the safe level. In some instances, the technicians can be notified before others so the the machine or device is reconfigured long before it reaches an unsafe level. Others can be notified at a different level when a dangerous condition presents itself. In other words, there is the option to have a first notification at a first level and a second notification at a second level of radiation. The first radiation amount and the second radiation amount can be retrieved from different sources. This is important, in some embodiments, because the source of the radiation amount may not always be in the same place. For example, in some instances, one radiation is retrieved from a modality or from the device that produces radiation. The other radiation amount can be retrieved from a medical data archive. In still another example embodiment, the radiation amount can be retrieved from a cloud storage location.

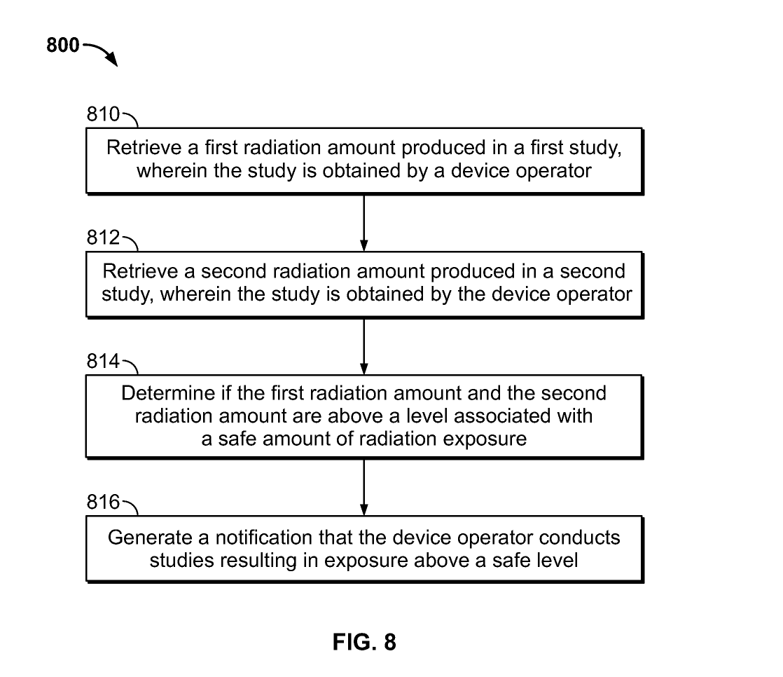

FIG. 8 is a flow diagram of a computerized method 800, according to still an another example embodiment. The computerized method 800 includes retrieving a first radiation amount produced in a first study, wherein the study is obtained by a device operator 810, and retrieving a second radiation amount produced in a second study 812. The studies retrieved have a device operator in common. In other words, studies done by the same technician can be looked at to determine if there might be problems or opportunities to educate the the technician or operator to fix a problem with operation of the imaging device. The method 800 also includes determining if the first radiation amount and the second radiation amount are above a level associated with a safe amount of radiation exposure 814. If they are, a notification is generated indicating that the device operator conducts studies resulting in exposure above a safe level or too near a safe level 816. The method can also include generating a radiation report that contains at least the first radiation amount, the second radiation amount, and identifying the device operator. The method radiation report can be retrieved from different sources. In addition, the radiation report is obtainable from a station on a network that includes a plurality of medical imaging devices. If the station has the capability to perform a DICOM retrieve, for example, the station can be used to obtain the report from any number of places where it would be stored on the medical network or the cloud. The method further includes storing the radiation report or the information from which the radiation report or parts of it can be generated on the cloud or in cloud storage.

A system includes a network that includes a plurality of medical imaging devices, the plurality of medical imaging devices including a media writing device. The system also includes a cloud apparatus communicatively coupled to the network, and a radiation report generator module communicatively coupled to the network. The radiation report generator is capable of storing a generated radiation report in the cloud apparatus or in at least one of the plurality of medical imaging devise communicatively coupled to the network. In another embodiment, the media writing device includes a writer or burner which writes the radiation report to a media. The radiation report can be obtained from a storage location such as cloud storage or archive storage or the like. In another embodiment, the writer burns or places locational information on the media so that a generated radiation report can be generated and sent to a computer communicatively coupled to an internet connection. The locational information can be a website address or an address for connecting to the cloud. The report including instructions for displaying the report on a display associated with the computer.

In another embodiment, the media writing device includes a writer, and the writer writes an instruction for retrieving radiation information and generating the radiation report, and sending it to a computer communicatively coupled to the internet. In still a further embodiment, the instructions for retrieving radiation information includes commands to the report generating module to generate the radiation report. In yet another embodiment, at least one of the plurality of medical devices communicatively coupled to the network has the ability to retrieve the radiation report from the report generating module or the cloud.

It is contemplated that yet another invention includes media having an instruction set thereon for generating radiation reports. It is further contemplated that any of the methods described above may be included as non-transitory signals associated with a media. The instructions cause a processor to perform the method. Further it is contemplated that the instructions would transform a computer to a specialized machine capable of performing the a method.

This has been a detailed description of some exemplary embodiments of the invention(s) contained within the disclosed subject matter. Such invention(s) may be referred to, individually and/or collectively, herein by the term “invention” merely for convenience and without intending to limit the scope of this application to any single invention or inventive concept if more than one is in fact disclosed. The detailed description refers to the accompanying drawings that form a part hereof and which shows by way of illustration, but not of limitation, some specific embodiments of the invention, including a preferred embodiment. These embodiments are described in sufficient detail to enable those of ordinary skill in the art to understand and implement the inventive subject matter. Other embodiments may be utilized and changes may be made without departing from the scope of the inventive subject matter. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed:

1. A computerized method comprising:
querying a first source of data regarding a radiation amount produced in a first study;
querying a second source of data regarding a second radiation amount produced for a second study;
generating a radiation report including the first radiation amount and the second radiation amount;
determining if the amount of first radiation amount and the second radiation amount are safe amounts of radiation exposure
wherein the first radiation amount and the second radiation amount are added and wherein the first study and the second study are on the same patient.

2. The method of claim 1 wherein the first study and the second study expose an organ of a patient to the first radiation amount and the second radiation amount.

3. The method of claim 1 wherein the first study, the second study, and the radiation report are recorded onto a portable media.

4. The computerized method of claim 1 wherein at least one of the first source of data regarding a radiation amount produced in a first study and the second source of data regarding a radiation amount produced in a second study is a modality.

5. The computerized method of claim 1 wherein at least one of the first source of data regarding a radiation amount produced in a first study and the second source of data regarding a radiation amount produced in a second study is a device that produces radiation.

6. The computerized method of claim 1 wherein at least one of the first source of data regarding a radiation amount produced in a first study and the second source of data regarding a radiation amount produced in a second study is a medical data archive.

7. The computerized method of claim 1 wherein at least one of the first source of data regarding a radiation amount produced in a first study and the second source of data regarding a radiation amount produced in a second study is at a cloud storage location.

8. A computerized method comprising:
retrieving a first radiation amount produced in a first study from a device;
retrieving a second radiation amount produced in a second study from the device;
generating a radiation report including the first radiation amount and the second radiation amount;
determining if the first radiation amount and the second radiation amount are above a level associated with a safe amount of radiation exposure;
resetting the configuration settings of the device in response to determining that the first radiation amount and the second radiation amount above a safe level.

9. The method of claim 8 wherein the determination that the first radiation amount and the second radiation amount are above a safe level triggers a notification of the condition.

10. The method of claim 1 wherein the first radiation amount and the second radiation amount is retrieved from different sources.

11. The computerized method of claim 10 wherein at least one of the first radiation amount and the second radiation amount is retrieved from a modality.

12. The computerized method of claim 10 wherein at least one of the first radiation amount and the second radiation amount is retrieved from the device that produces radiation.

13. The computerized method of claim 10 wherein at least one of the first radiation amount and the second radiation amount is retrieved from a medical data archive.

14. The computerized method of claim 10 wherein at least one of the first radiation amount and the second radiation amount is retrieved from a cloud storage location.

15. A computerized method comprising:
retrieving a first radiation amount produced in a first study, wherein the study is obtained by a device operator;
retrieving a second radiation amount produced in a second study, wherein the study is obtained by the device operator;
determining if the first radiation amount and the second radiation amount are above a level associated with a safe amount of radiation exposure;
generating a notification that the device operator conducts studies resulting in exposure above a safe level.

16. The method of claim 15 further comprising generating a radiation report including the first radiation amount, the second radiation amount, and identifying the device operator.

17. The method of claim 16 wherein the radiation report is retrieved from different sources.

18. The method of claim 16 wherein the radiation report is obtainable from a station on a network that includes a plurality of medical imaging devices.

19. The method of claim 16 wherein the radiation report is obtainable from a cloud storage location.

20. A system comprising:
a network that includes a plurality of medical imaging devices, the plurality of medical imaging devices including a media writing device;
a cloud apparatus communicatively coupled to the network;
a radiation report generator module communicatively coupled to the network, the radiation report generator capable of storing a generated radiation report in the cloud apparatus or in at least one of the plurality of medical imaging devise communicatively coupled to the network.

21. The system of claim 20 wherein the media writing device includes a writer, the writer writing the radiation report to a media.

22. The system of claim 20 wherein the media writing device includes a writer, the writer writing locational information to the media so that a generated radiation report can be obtained from a storage location.

23. The system of claim 22 wherein the media writing device includes a writer, the writer writing locational information to the media so that a generated radiation report can be generated and sent to a computer communicatively coupled to an internet connection, the report including instructions for displaying the report on a display associated with the computer.

24. The system of claim 20 wherein the media writing device includes a writer, the writer writing an instruction for retrieving radiation information and generating the radiation report, and sending it to a computer communicatively coupled to the internet.

25. The system of claim 24 wherein the instructions for retrieving radiation information includes commands to the report generating module to generate the radiation report.

26. The system of claim 20 wherein at least one of the plurality of medical devices communicatively coupled to the network has the ability to retrieve the radiation report from the report generating module.

27. The system of claim 26 wherein the at least one of the plurality of medical devices communicatively coupled to the network has to ability to retrieve the radiation report from the cloud.
